(19) United States
(12) Patent Application Publication
(10) Pub. No.: US 2015/0144450 A1
(43) Pub. Date: May 28, 2015

(54) CAGE BLANK FOR A FREE WHEEL, FREE WHEEL CAGE FORMED FROM SUCH A BLANK, FREE WHEEL COMPRISING SUCH A CAGE AND METHOD FOR ASSEMBLING SUCH A FREE WHEEL

(71) Applicants: Charles CHAMBONNEAU, Joue les Tours (FR); Samuel VIAULT, Saint-Antoine-du-Rocher (FR)

(72) Inventors: Charles CHAMBONNEAU, Joue les Tours (FR); Samuel VIAULT, Saint-Antoine-du-Rocher (FR)

(73) Assignee: AKTIEBOLAGET SKF, Goteborg (SE)

(21) Appl. No.: 14/552,649

(22) Filed: Nov. 25, 2014

(30) Foreign Application Priority Data
Nov. 25, 2013 (FR) 1361594 FR

(51) Int. Cl. F16D 41/06

(52) U.S. Cl. CPC F16D 41/06; F16D 2300/12
USPC 192/45.006; 29/428

(57) ABSTRACT

The cage blank for a free wheel with at least one of rolling bodies and cams wherein the cage blank has two parts and comprises a main part defining cells for receiving the at least one of rolling bodies and cams. The cage blank includes a cover for closing the cells. Before the cover is assembled on the main part, each cell has, at an axial end, along a longitudinal axis of the main part, an opening for placing a rolling body or a cam.

### CROSS REFERENCE TO RELATED APPLICATION

This is a National Stage application claiming the benefit of French Patent Application Number 1361594 FR filed on 25 Nov. 2013 (25 Nov. 2013), which is incorporated herein by reference in its entirety.

### FIELD OF THE INVENTION

The invention relates to a cage blank for a free wheel with rolling bodies and/or cams, such a blank being used during the manufacture of a free wheel in order to produce a cage for keeping rolling bodies in position during use of the free wheel. The invention also relates to a free wheel cage formed from such a blank, as well as a free wheel comprising such a cage. Lastly, the invention relates to a method for assembling such a free wheel.

### BACKGROUND ART

In the field of free wheels, it is known to keep rolling bodies of the free wheel, such as rollers or beads, and/or cams, in position using a single-piece cage that defines housings for receiving and guiding rolling bodies or cams, between the inner and outer rings of the free wheel. Such a single-piece cage may be formed by a folded and cut metal strip or by a ring made from molded synthetic material. With this type of cage, the rolling bodies and the cams must be introduced successively into the cells of the cage from the inside or from the outside thereof, which requires precise manipulations and a qualified workforce. This makes the price of a free wheel incorporating such a cage higher.

The invention more particularly aims to resolve these drawbacks by proposing a cage blank for a free wheel that facilitates the placement of the rolling bodies and/or cams, while making it possible to save time during the manufacturing of a free wheel.

### SUMMARY OF THE INVENTION

To that end, the invention relates to a blank for a free wheel with rolling bodies and/or cams, characterized in that it has two parts and comprises a main part defining cells for receiving rolling bodies and/or cams, as well as a cover for closing the cells, that main part and that cover being made from a molded plastic material, whereas, before the cover is assembled on the main part, each cell has, at an axial end, along a longitudinal axis of the main part, an opening for placing a rolling body or a cam.

Owing to the invention, the blank may be equipped or “trimmed” with rolling bodies and/or cams through the axial end openings of the cells before placing the cover on the main part. It is thus possible to perform axial loading of the main part by manipulating the rolling bodies and/or the cams in a single direction parallel to the longitudinal axis of the main part of the blank. This facilitates an operator's work, or even it makes it possible to automate the task of placing rolling bodies and/or cams. The invention also makes it possible to place rolling bodies and/or cams in the cells simultaneously, which saves considerable time relative to the prior art, where the different rolling bodies and/or cams must be introduced one after the other into their respective cells.

According to advantageous but optional aspects of the invention, such a blank may incorporate one or more of the following features, considered in any technically allowable combination:
The main part comprises a ring centered on the longitudinal axis of the main part, and several bars that extend parallel to the longitudinal axis and between which the cells are defined.
At least some of the bars bear, at their free end furthest from the ring, means for assembling the cover.
The mounting means comprise, for at least one bar, a slug protruding relative to a part of the bar that delimits a cell, whereas the cover is provided with at least one housing for receiving a slug of a bar.
Each bar is provided with a protruding slug at its axial end and the cover is provided with housings for receiving the slugs, in a number equal to the number of bars.
At least some of the bars bear, at their axial end, a snapping tongue for snapping the cover in place on the main part.
At least one bar defines a housing for receiving an elastic member for returning a rolling body or a cam received in a cell adjacent to the bar to a predetermined position, that housing emerging in the axial end opening of the adjacent cell.
The main part and/or the cover are made from polyamide filled with glass fibers, in particular PA66-GF25 or PA46-GF25, polyether ether ketone filled with glass fibers, or PEEK.

The invention also relates to a cage for a free wheel with rolling bodies and/or cams formed from a blank as described above and in which the cover is assembled on the main part.

The invention further relates to a free wheel with rolling bodies and/or cams that comprises an inner ring, an outer ring, several rolling bodies and/or several cams each positioned in an annular space arranged radially between the inner and outer rings, as well as a cage as mentioned above that keeps the rolling bodies and/or the cams in position in the annular space.

Lastly, the invention relates to a method for assembling a free wheel as mentioned above, the method comprising the following steps:
a) installing the main part in a configuration where it is separated from the cover;
b) trimming the cells of the main part by inserting rolling bodies and/or cams therein through their respective axial end openings, via a movement parallel to the longitudinal axis of the main part;
c) closing off the axial end openings of the cells by mounting the cover on the main part.

### BRIEF DESCRIPTION OF THE DRAWINGS

The invention will be better understood and other advantages thereof will appear more clearly in light of the following description of one embodiment of a blank, a cage and a free wheel according to its principle, as well as a method for assembling such a free wheel also according to its principle, provided solely as an example and done in reference to the appended drawings, in which:

FIG. 1 is an exploded perspective view of a free wheel blank according to the invention,

FIG. 2 is a cross-section of the main part of the blank of FIG. 1, on which the cover visible in FIG. 1 is mounted and which is equipped with rollers for reacting radial loads and springs for returning cams to their positions that are not shown in this figure; this section is taken looking at the cover assembled on the main part,

FIG. 3 is an exploded perspective view of a free wheel according to the invention,

FIG. 4 is an axial cross-section of the free wheel of FIG. 3 in the assembled configuration,

FIG. 5 is a cross-section of the free wheel, along line V-V in FIG. 4, where IV-IV indicates the cutting plane of FIG. 4,

FIG. 6 is a cross-section along line VI-VI in FIG. 5, and

FIG. 7 is an enlarged view of detail VII in FIG. 6.

### DETAILED DESCRIPTION OF EXEMPLARY EMBODIMENTS OF THE INVENTION

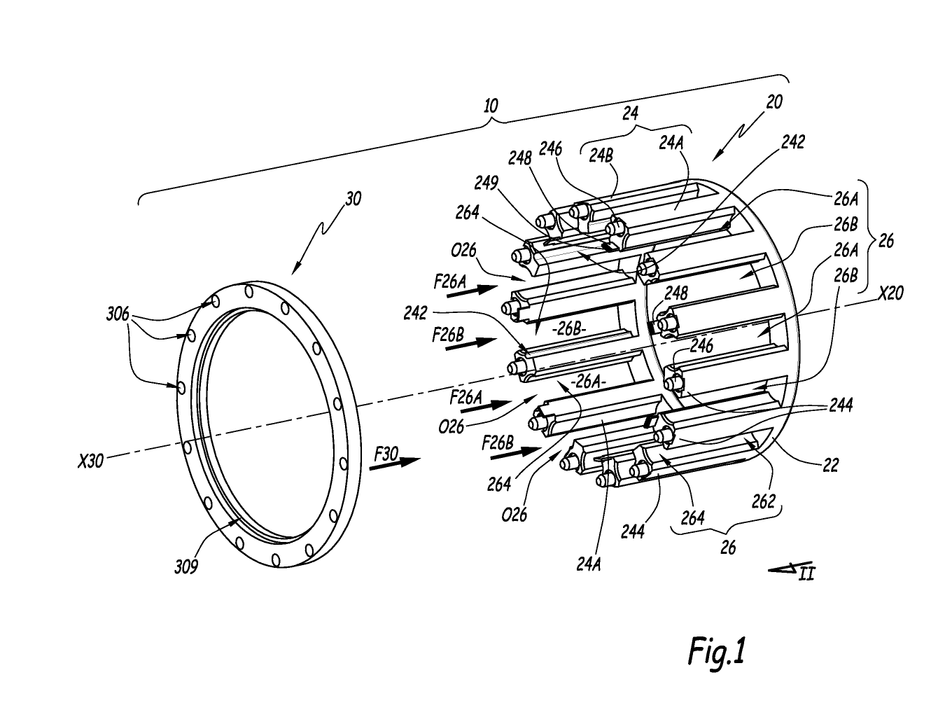

FIG. 1 shows a cage blank 10 for a free wheel. This blank is obtained by molding plastic material such as polyamide filled with glass fibers, for example PA66-GF25 or PA46-GF25, polyether ether ketone filled fibers or PEEK. This blank has two parts and comprises a main part 20 and a cover 30 that are molded separately and assembled to each other when a free wheel cage is made from the blank 10. The main part 20 is centered on a longitudinal axis X20 that is an axis of symmetry for a ring 22 from which fourteen bars 24 extend, each along a longitudinal axis A24 parallel to the axis X20.

The bars 24 all extend on the same side of the ring, along the axis X20. The bars 24 define two types of cells 26 between them, namely:
cells 26A intended to receive the rollers 40 for reacting radial forces between the inner and outer rings of a free wheel, and
cells 26B intended to receive cams 50 for selectively blocking the relative rotation of the inner and outer rings of the free wheel.

In practice, fourteen cells 26 are provided with an alternating distribution of the cells 26A and 26B. In other words, in an orthoradial direction relative to the axis X20, a cell 26A is positioned between two cells 26B, and vice versa.

Along the axis X20, each cell 26 extends between a first end 262, defined in the vicinity of the ring 22 and which is closed off, along the axis X20, by that ring, and a second end 264 that emerges outwardly, axially along the axis X20, through an opening 026. Each opening 026 has, in a plane perpendicular to the axis X20, dimensions compatible with the insertion of a roller 40 or a cam 50 into the corresponding opening 26, in a direction parallel to the axis X20 and which is shown by arrows F26 in FIG. 1.

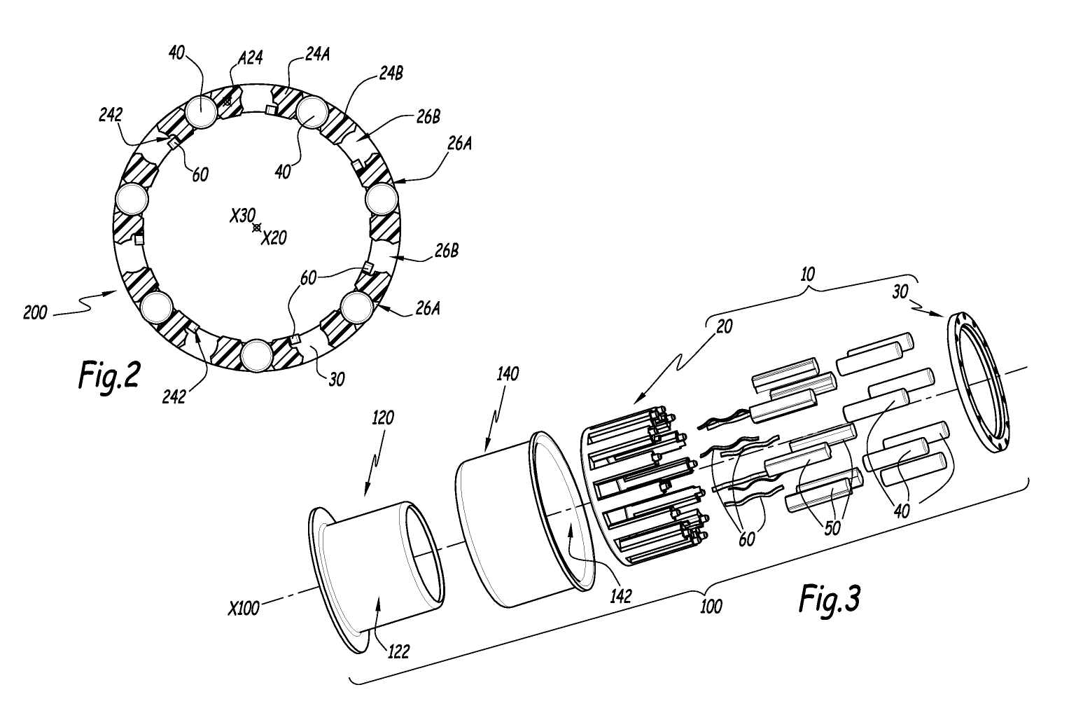

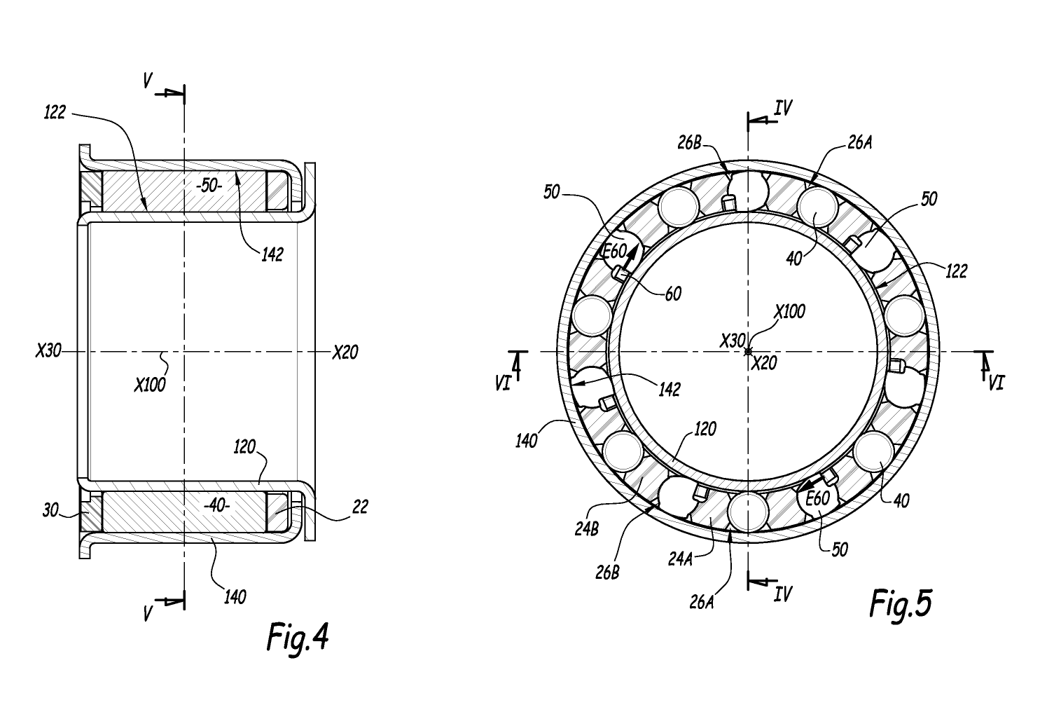

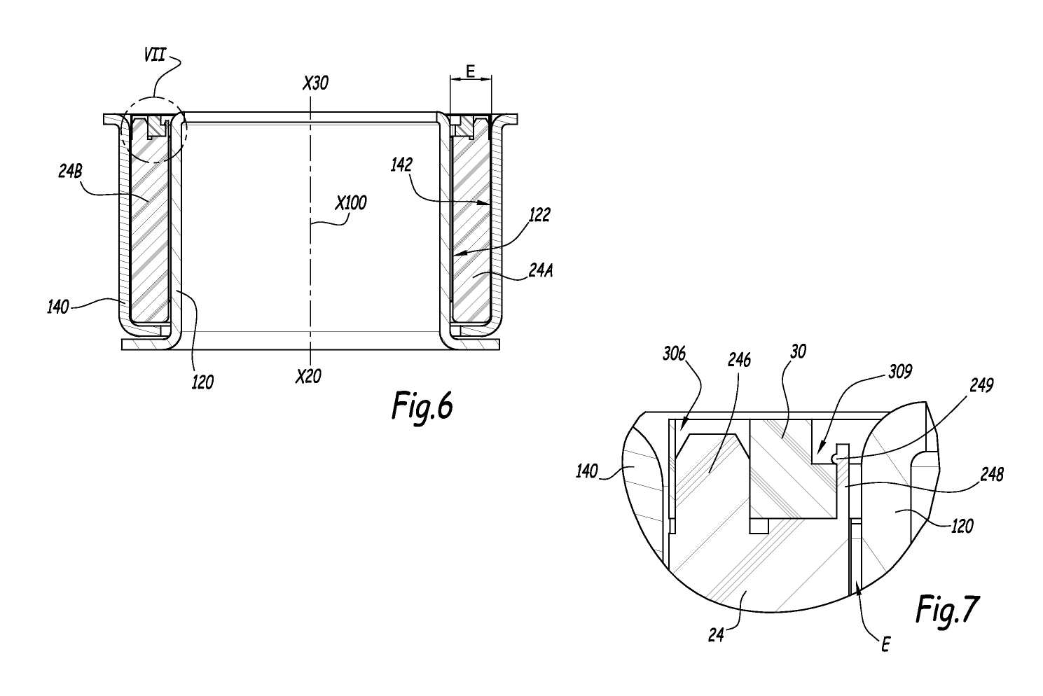

The bars 24 are not all identical and are broken down into two types of bars 24A and 24B. When one looks at the main part 20 in the direction of arrow II in FIG. 1, which corresponds to the direction of the cross-section of FIG. 2, each part 24A is situated, in the clockwise direction, before a cell 26A and after a cell 26B. Likewise, a bar 24B is situated before a cell 26B and after a cell 26A in the clockwise direction. In other words, the bars 24A and 24B alternate around the axis X20.

Each bar 24A is provided, on its side oriented toward the adjacent cell 26B, with a housing 242 for receiving an elastic member 60 formed by a leaf spring and which serves to exert, on the cam 50 received in the cell 26B in question, an elastic force E60 returning the cam to a so-called “neutral” position where it does not oppose the relative rotation between the inner and outer rings of a free wheel provided with a cage formed from the blank 10 and equipped with elements 40, 50 and 60.

Reference 244 denotes the free axial end of a bar 24 opposite the ring 22. The openings 026 are defined between the ends 244 of the bars 24 and the cells 26 extend, along the axis X20, between those ends 244 and the ring 22. Beyond each end 244 relative to the ring 22, each bar 24 is provided with a protruding slug 246. Furthermore, each bar 24A is equipped with an elastically deformable tongue 248 that also protrudes relative to its end 244 and is provided with a rib 249 oriented radially outwardly relative to the axis X20. Such a rib is sometimes called a “godroon”.

The cover 30 has an annular shape and is centered on an axis X30 that is superimposed with the axis X20 in the configuration of the cover 30 assembled on the main part 20. In a plane perpendicular to the axis X30, the dimensions of the cover 30 are equivalent to the dimensions of the ring 22 in a plane perpendicular to the axis X20.

The cover 30 is provided with fourteen orifices 306 that form the same number of receiving housings for the slugs 246 in the configuration of that the cover 30 assembled on the main part 20. On its inner radial edge turned toward the axis X30, the cover 30 is provided with a fold 309 for receiving the ribs 249 of the different tongues 248. Thus, the cover 30 can be guided when it is assembled on the main part 20 by the different slugs 246 that penetrate the orifices 306, which performs a relative centering operation of the parts 20 and 30. The fact that the cover 30 abuts against the ends 244 of the bars 24 ensures immobilization of the cover 30 on the part 20 in a direction coming closer to the ring 22. Additionally, the ribs 249 cooperate with the fold 309 to immobilize the cover 30 against tearing out, i.e., in a direction moving away from the ring 22. Thus, the tongues 248 perform a snapping function of the cover 30 on the main part 20, as in particular shown in FIG. 7.

The free wheel 100 shown in FIGS. 3 and following is centered on an axis X100 combined with the axes X20 and X30 in the assembled configuration of the free wheel. The free wheel 100 comprises an inner ring 120 centered on the axis X100 and an outer radial surface 122 of which defines a track used for rolling for the rollers 40 and jamming for the cams 50. The free wheel 100 also comprises an outer ring 140 centered on the axis X100 and an inner radial surface 142 of which defines a track used for rolling for the rollers 40 and jamming for the cams 50.

When the free wheel 100 needs to be assembled, the component elements 20 and 30 of the blank 10 are positioned in a configuration where the cover 30 is separated from the main part 20.

The cells 26A are then trimmed with the rollers 40 by inserting each roller 40 into the corresponding cell 26A in a direction parallel to the axis X20 and shown by arrow F26A in FIG. 1. This placement of the rollers 40 in the cells 26A takes place through the axial end openings 026 of those cells Likewise, the cams 50 are placed in the cells 26B, through the axial end openings 026 of those cells, in a direction parallel to the axis X20 and as shown by the arrows F26B. Before or after the cams 50 are placed in the cells 26B, the springs 60 are placed in the housings 242, through the openings 026 and those cells and in the direction of arrows F26B.

Once placed in the housings 242, the springs 60 exert the elastic force E60 on the cams 50 that returns those cams to a position where they do not block a relative rotation between the rings 120 and 140, as mentioned above.

When the different elements 40, 50 and 60 are in place in the cells 26, the cover 30 can be attached on the main part 20, by aligning the axes X20 and X30 and pressing the cover on that main part in the direction of arrow F30 in FIG. 1, which results in causing the slugs 246 to penetrate the orifices 306 and bring the ribs 249 into the flap 309. This results in closing off the openings 026 using the cover 30, such that the elements 40, 50 and 60 are kept in position in the cells 26.

In this respect, the transverse dimensions of the cells 26, in particular in an orthoradial direction relative to the axis X20, are chosen so that the elements 40, 50 and 60 do not risk sliding inside the cells, radially toward the inside or outside of the bars 24, when a cage 200, made up of assembled parts 20 and 30 and equipped with elements 40, 50 and 60, is manipulated.

It will be understood that since the elements 40, 50 and 60 are placed in the cells 26 using axial movements parallel to the axis X20, this requires a less specialized workforce than that needed to place such members through the inside of a single-piece cage. This makes it possible to consider a simultaneous placement of these elements in the corresponding cells, for example using a handling robot.

The cage 200 can then be placed in an annular space E defined, radially relative to the axis X100, between the tracks 122 and 142. This cage 200, equipped with the elements 40, 50 and 60, can be manipulated as a single-piece sub-assembly, which facilitates the assembly of the free wheel 100.

According to one alternative not shown in the invention, all of the bars 24 can be equipped with an elastically deformable tongue 248 to improve the snapping of the cover 30 on the main part 20. Additionally or as an alternative to the use of the snapping tongues 248, the cover 30 can be glued or welded on the main part.

The number of cells of the cage 200 according to the invention is not necessarily equal to fourteen and may assume different values, in particular based on the diameters of the ring 22 and the rollers 40 and the transverse dimensions of the cams 50.

The invention is also applicable to a free wheel that comprises only rollers 50, in which case one of the tracks 122 and 142 can be provided with cams for selectively jamming those rollers, or only with cams 50 that then also perform a radial load reacting function. In that case, the springs 60 are provided to act on the rollers 40.

The springs 60 are optional.

The embodiments and alternatives considered above may be combined to generate new embodiments.

1. A blank for a cage for a free wheel with at least one of rolling bodies and cams, the blank comprising:
two parts and a main part defining cells for receiving at least one of rolling bodies and cams, a cover for closing the cells, wherein the main part and the cover are made from a molded plastic material, wherein, before the cover is assembled on the main part, each cell has, at an axial end, along a longitudinal axis of the main part, an opening for placing one of a rolling body or a cam.

2. The blank according to claim 1, the main part further comprising a ring centered on the longitudinal axis of the main part, and several bars that extend parallel to the longitudinal axis and between which the cells are defined.

3. The blank according to claim 2, wherein at least some of the bars bear an assembly feature for assembling the cover, wherein the assembly feature is located at a free end furthest from the ring.

4. The blank according to claim 3, wherein the assembly feature includes, for at least one bar of the several bars, a slug protruding relative to a part of the bar that delimits a cell, and in that the cover is provided with at least one housing for receiving a slug of the at least one bar of the several bars.

5. The blank according to claim 4, wherein each bar of the several bars is provided with a protruding slug at an axial end of the associated bar and the cover is provided with housings for receiving the slugs, in a number equal to the number of bars.

6. The blank according to claim 3, wherein at least some of the bars bear further comprise a snapping tongue for snapping the cover in place on the main part, wherein the snapping tongue is located at an axial end of the associated bar.

7. The blank according to claim 2, wherein at least one bar defines a housing for receiving an elastic member for returning one of the rolling body and the cam received in a cell adjacent to the bar to a predetermined position, that housing emerging in the axial end opening of the adjacent cell.

8. The blank according to claim 1, wherein at least one of the main part and the cover are made from polyamide filled with glass fibers.

9. A cage for a free wheel with at least one of rolling bodies and cams formed from a blank wherein the blank includes:
two parts and a main part defining cells for receiving at least one of rolling bodies and cams, a cover for closing the cells, wherein the main part and the cover are made from a molded plastic material,
wherein, before the cover is assembled on the main part, each cell has, at an axial end, along a longitudinal axis of the main part, an opening for placing one of a rolling body or a cam;
in which the cover is assembled on the main part.

10. A free wheel with at least one of rolling bodies and cams, the free wheel comprising:
an inner ring;
an outer ring;
several at least one of the rolling bodies and the cams are each positioned in an annular space arranged radially between the inner and outer rings;
a cage that keeps at least one of the rolling bodies and the cams in position in the annular space,
wherein the cage is adapted for a free wheel with at least one of the rolling bodies and the cams formed from a blank wherein the blank includes:
two parts and a main part defining cells for receiving at least one of the rolling bodies and the cams, a cover for closing the cells, wherein the main part and the cover are made from a molded plastic material,
wherein, before the cover is assembled on the main part, each cell has, at an axial end of the cell, along a longitudinal axis of the main part, an opening for placing one of the rolling body or the cam;
in which the cover is assembled on the main part.

11. A method for assembling a free wheel, the method comprising steps of:
a) obtaining components of a free wheel, the components comprising:
an inner ring,
an outer ring,
several of at least one of the rolling bodies and the cams are each positioned in an annular space arranged radially between the inner and outer rings, and
a cage that keeps the at least one of the rolling bodies and the cams in position in the annular space,
wherein the cage is adapted for a free wheel with at least one of rolling bodies and cams formed from a blank wherein the blank includes:
two parts and a main part defining cells for receiving at least one of rolling bodies and cams, a cover for closing the cells, wherein the main part and the cover are made from a molded plastic material,
wherein, before the cover is assembled on the main part, each cell has, at an axial end, along a longitudinal axis of the main part, an opening for placing one of a rolling body or a cam;
in which the cover is assembled on the main part;
b) installing the main part in a configuration where it is separated from the cover;
c) trimming the cells of the main part by inserting at least one of the rolling bodies and the cams therein through their respective axial end openings, via a movement parallel to the longitudinal axis of the main part; and
d) closing off the axial end openings of the cells by mounting the cover on the main part.
